(19) United States
(12) Patent Application Publication
(10) Pub. No.: US 2007/0201793 A1
(43) Pub. Date: Aug. 30, 2007

(54) MULTI-CORE OPTICAL FIBER AND METHOD OF MAKING AND USING SAME

(76) Inventors: CHARLES ASKINS, Upper Marlboro, MD (US); Joseph Friebele, Cheverly, MD (US); Gary A. Miller, Alexandria, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/676,036

(22) Filed: Feb. 16, 2007

Related U.S. Application Data
(60) Provisional application No. 60/774,214, filed on Feb. 17, 2006.

(51) Int. Cl. G02B 6/34; G02B 6/00; G02F 1/295

(52) U.S. Cl. 385/37; 385/134; 385/136; 385/137; 385/31; 385/4; 385/5

(57) ABSTRACT

The apparatus includes a fiber comprising an axial center, a central single-mode waveguiding core and a plurality of peripheral single-mode waveguiding cores. The central core is located at a first distance from the axial center. The plurality of peripheral cores is located at respective second distances from the axial center. Each of the respective second distances is greater than the first distance, and each peripheral core of the plurality of peripheral cores follows a respective first helix about the axial center. The central core and the plurality of peripheral cores include an optical strain sensor rosette.

### TECHNICAL ART

The invention relates generally to optical fibers, and more specifically to multi-core optical fibers for use in measuring twist, bend, and/or temperature.

### BACKGROUND ART

Many applications involving long, narrow and flexible structures (e.g., cables, tethers, etc.) would gain by knowing the 3-dimensional shape of those structures as they are deflected. For structures that have large cross-sections compared with those typical of optical fiber, shape monitoring has been proposed through the attachment of multiple, one-dimensional fiber-optic strain-sensing arrays, for example, as disclosed in U.S. Pat. No. 6,728,431 to Ames, incorporated herein by reference.

Several prior methods employing optical fibers to sense bending are not discussed in depth here because of their intrinsic limits of sensitivity and specificity, or where few of these devices could be operated serially in a single fiber optic core. Examples would include sensors based on bend-induced loss, or the use of long period gratings. For example, H. J. Patrick et al, “Long period fiber gratings for structural bend sensing”. Elec. Lett., Vol. 34, p. 1773 (1998), incorporated herein by reference, used the spectral properties of long period gratings in asymmetrical fibers to indicate bending in one dimension.

Other authors have recognized or proposed the potential to evaluate bending in one or two dimensions by measuring the differential strain at different locations within the fiber's cross section by optically measuring the strain present in multiple light-guiding cores, all oriented parallel to the long axis of the fiber. For example, G. M. H. Flockhart et al, “Two-axis bend measurement with Bragg gratings in multicore optical fiber”, Opt. Lett. Vol. 28, p. 387 (2003), incorporated herein by reference, the wavelengths of fiber Bragg gratings (FBGs) written each of the multiple cores of a fiber are measured, and the inferred strains are used to compute curvature from the basic relation:

$$ρ = \frac{d}{Δ ɛ}$$

where ρ is the radius of curvature of the fiber, and Δε is the difference in axial strain measured in two cores separated by d. In this simplest form for one-dimensional bending, the two cores lie in the plane of bending. A three-dimensional generalization considers three or more cores not all in the same plane, and the proportions of the several differential strains allows determination of bend magnitude and orientation. Prior art employing this approach includes multiple sets of such gratings placed along the fiber's length for determining bending at multiple locations.

For example, P. M. Blanchard et al, “Two dimensional bend sensing with a single, multi-core optical fibre”, Smart Materials and Structures, Vol. 9, pp. 132-140 (2000), incorporated herein by reference, evaluate the difference in the optical path length between several cores in a fiber to infer bending, with the assumption that a single bending mode is present.

In U.S. Pat. No. 6,888,623 to Clements, both bending and torsion are considered, but strain measurements are not considered directly. Rather, the variation in evanescent coupling between adjacent cores in a fiber (measured over a range of wavelengths) is said to give unique and distinguishable sets of signals (power spectra detected in each of the several cores) for an accepted range of combined bending and twisting.

### DISCLOSURE OF THE INVENTION

An embodiment of the instant invention includes a method of manufacture. The method includes providing a multi-core, single-mode optical fiber pre-form comprising a center single-mode core and a periphery. A plurality of longitudinal grooves are machined along the periphery. A plurality of peripheral single-mode cores are inserted in said plurality of longitudinal grooves. The pre-form is over-sleeved with a glass tube prior to a fiber draw. Optionally, each peripheral single-mode core of the plurality of peripheral single-mode cores includes a respective index of refraction and/or a respective photosensitivity. Optionally, the plurality of peripheral single-mode cores include a reference single-mode core and at least two remaining peripheral single-mode cores, wherein the reference single-mode core and the center single-mode core include a plane perpendicular to the fiber cross-section. The plane is free of the at least two remaining peripheral single-mode cores. The respective photosensitivity of each remaining peripheral single-mode core of the at least two remaining peripheral single-mode cores is adjusted to correspond to an angular position relative to the plane. Optionally, a first azimuthal angle, lies in the fiber cross-section and is formed by the reference single mode core, the center single mode core, and a first remaining peripheral single-mode core of the at least two remaining peripheral single-mode cores, is the same as a second azimuthal angle, lying in the fiber cross-section and formed by the reference single mode core, the center single mode core, and a second remaining peripheral single-mode core of the at least two remaining peripheral single-mode cores.

Another embodiment of the invention includes a method of manufacture including providing a multi-core single-mode optical fiber during a fiber draw process. A rotation is imparted to the multi-core single-mode optical fiber. A rate of the rotation is measured by side illumination with a laser. A light scatter pattern is detected. The rate of the rotation in the rotation-imparting step is controlled by adjusting a cross-roller assembly in response to the detected light scatter pattern, thereby producing a permanent twist in the multi-core single-mode optical fiber drawn by the fiber draw process. Optionally, the multi-core single-mode optical fiber includes a length, a longitudinal axis, and a fiber cross-section. The detecting a light scatter pattern includes directing a laser beam toward the multi-core single-mode optical fiber in a direction normal to the longitudinal axis to generate the light scatter pattern determined by the fiber cross-section; displaying the light scatter pattern; and moving a point of incidence of the laser beam along the length of the fiber to measure an amount of twist in the multi-core single-mode optical fiber.

Another embodiment of the invention includes method of manufacture. The method includes providing a multi-core single-mode optical fiber. The multi-core single-mode optical fiber is rotationally oriented. A rotational orientation of the fiber is measured by side illumination with a monitoring laser, wherein the side illumination is substantially free of an effect on the index of refraction of the multi-core single-mode optical fiber. A light scatter pattern is detected. Based on the detected light scatter pattern, the rotational orientation is adjusted in the rotationally orienting the multi-core single-mode optical fiber. A fiber Bragg grating is produced in the fiber. Optionally, the multi-core single-mode optical fiber includes a center single-mode core, a fiber cross-section, and a periphery. The multi-core single-mode optical fiber including a plurality of longitudinal grooves along the periphery. The multi-core single-mode optical fiber includes a plurality of peripheral single-mode cores located in the plurality of longitudinal grooves. Each peripheral single-mode core of the plurality of peripheral single-mode cores includes a respective index of refraction and/or a respective photosensitivity. The plurality of peripheral single-mode cores includes a reference single-mode core and at least two remaining peripheral single-mode cores. The reference single-mode core and the center single-mode core include a plane perpendicular to the fiber cross-section, the plane being free of the at least two remaining peripheral single-mode cores. The respective photosensitivity of each remaining peripheral single-mode core of the at least two remaining peripheral single-mode cores corresponds to an angular position relative to the plane. Optionally, the adjusting, based on the detected light scatter pattern, the rotational orientation in the rotationally orienting the multi-core single-mode optical fiber is performed until the light scatter pattern includes reduced intensity regions projected by the plurality of peripheral single-mode cores. The light scatter pattern corresponds to rotational alignment of the plurality of peripheral single-mode cores with the laser, wherein the reference single-mode core of the plurality of peripheral single-mode cores is distal to the monitoring laser relative to the at least two remaining peripheral single-mode cores. Optionally, a laser optical field is modified by interposing a filamentary attenuator between the fiber and the laser such that a laser beam cross-section comprises a selectively attenuated intensity field. Optionally, the selectively attenuated intensity field is aligned with light illuminating the reference single-mode core of the plurality of peripheral single-mode cores to attenuate exposure of the reference single-mode core of the plurality of peripheral single-mode cores.

Another embodiment of the invention includes an apparatus. The apparatus includes a fiber comprising an axial center, a central single-mode waveguiding core and a plurality of peripheral single-mode waveguiding cores. The central core is located at a first distance from the axial center. The plurality of peripheral cores is located at respective second distances from the axial center. Each of the respective second distances is greater than the first distance, and each peripheral core of the plurality of peripheral cores follows a respective first helix about the axial center. The central core and the plurality of peripheral cores include an optical strain sensor rosette. Optionally, the central core is located coincident with said axial center. Optionally, the fiber comprises an optical surface, the plurality of peripheral cores is located at respective third distances from the optical surface. Optionally, each of the respective third distances is greater than a diameter of a corresponding peripheral core of said plurality of peripheral cores. Optionally, the central core follows a second helix about the axial center. Optionally, each of the first helices comprise a same rotational handedness. Optionally, said optical strain sensor rosette comprises a plurality of optical strain sensors located at a substantially same fiber length coordinate. Optionally, each optical strain sensor of the plurality of optical strain sensors includes a fiber Bragg grating or an optical cavity.

An embodiment of the instant invention is useful in applications where shape sensing is required in a structure having a cross section comparable to that of an optical fiber, or where the structure itself is an optical fiber. The 3-dimensional shape of a fiber generally implies both bending and torsion if the fiber is compliant in both of these types of deflection, “torsion” referred herein to elastic deformation about the long axis. A calculated reconstruction of the fiber's shape from measurements of internal strain requires the distinct evaluation of both bending and torsion.

### BRIEF DESCRIPTION OF THE DRAWINGS

FIG. 1 is a perspective view of a multi-core single-mode fiber according to an embodiment of the instant invention.

FIG. 2 is a perspective view of a pre-form according to an embodiment of the instant invention.

FIG. 3 is a cross-sectional view of a multi-core single-mode fiber according to an embodiment of the instant invention.

FIG. 4 is a cross-sectional view of a multi-core single-mode fiber according to an embodiment of the instant invention.

FIG. 5 is a block diagram relating to a method of manufacture according to an embodiment of the instant invention.

### DESCRIPTION OF THE PREFERRED EMBODIMENTS OF THE INVENTION

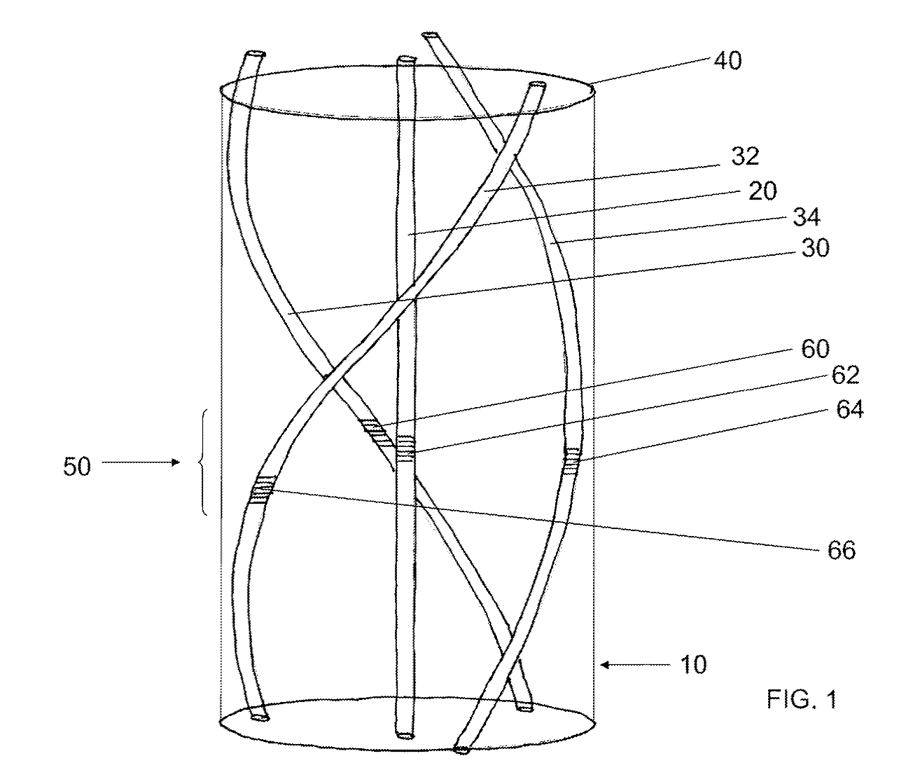

An embodiment of the invention includes an apparatus, shown by way of example in FIG. 1. The apparatus includes a fiber 10 comprising an axial center, a central single-mode waveguiding core 20 and a plurality of peripheral single-mode waveguiding cores 30, 32, 34. The central single mode core 20 is located at a first distance from the axial center. The plurality of peripheral cores 30, 32, 34 is located at respective second distances from the axial center. Each of the respective second distances is greater than the first distance, and each peripheral core of the plurality of peripheral cores 30, 32, 34 follows a respective first helix about the axial center.

Optionally, the central core 20 is located coincident with said axial center. Optionally, the fiber comprises an optical surface 40, the plurality of peripheral cores is located at respective third distances from the optical surface 40. Optionally, each of the respective third distances is greater than a diameter of a corresponding peripheral core of the plurality of peripheral cores 30, 32, 34. Optionally, the central core 20 follows a second helix about the axial center. Optionally, each of the first helices comprise a same rotational handedness.

Optionally, the central core 20 and the plurality of peripheral cores 30, 32, 34 include a plurality of optical strain sensor rosettes. (For simplicity, only one optical strain sensor rosette is shown in FIG. 1). Optionally, each optical strain sensor rosette 50 of the plurality of optical strain sensor rosettes comprises a plurality of optical strain sensors 60, 62, 64, 66 located at a substantially same fiber length coordinate. Optionally, each optical strain sensor of the plurality of optical strain sensors 60, 62, 64, 66 includes a fiber Bragg grating or an optical cavity.

An illustrative example of this embodiment is described as follows. The example includes a multi-core, twist-biased optical fiber with properties that enable distinct and concurrent measurement of local bending magnitude, bending direction, torsion magnitude, torsion direction, and temperature change at many locations along the fiber. One single-mode core is placed at or near the centerline of the fiber, and is near the “neutral axis” for bending and twisting. At least three additional (outer) single-mode cores are radially offset from the centerline of the fiber as far as is practical so as to maximize strain under bending. The locations of the outer cores are widely spaced in azimuthal angle to ensure large variation between strains measured in the several cores for all orientations of bending. The azimuthal positions of these “outer cores” are chosen to produce maximal differential strains for different bending directions. For example, symmetrical placement is used. For example, placement at approximately 120 degree intervals satisfies this requirement when there are three outer cores. Alternatively, two pairings of the three outer cores optionally have angular positions greater than or less than 120 degrees. Such an arrangement of the three outer cores produces a unique combination of compressive and tensile strains for every possible bend magnitude and direction. In order to usefully detect twisting, the fiber is manufactured with a fixed rotation (bias twist) of the cores about the fiber's axis. The degree of this bias twist may be expressed as the pitch length, or the distance along the axis over which one full revolution of the cores occurs. With bias twist, additionally applied torsion in the same direction as the bias will elongate the outer FBGs; the torsion in the opposite sense causes compression of these FBGs.

The outer cores are further described as following a helical path about the central core, such that the helices rotate about the center approximately 10 to 30 times per meter of distance along the fibre's length (i.e., the pitch length is approximately 0.1 to 0.03 meters). This helical pitch is present in the relaxed fiber, and constitutes the “twist bias”. At each considered location along the fiber's length, all cores bear a fiber Bragg grating (FBG) which exhibits nearly equivalent spectral properties (reflectivity, line-width, Bragg wavelength) while the fiber is mechanically relaxed. Nearly equivalent spectral properties, include for example, a center Bragg wavelength within 1 nanometer, a spectral line-width less than 1 nm +/−0.2 nm, and reflectivities within 50%. Each set of substantially axially collocated, matched FBGs constitutes a strain rosette for evaluating the set of four axial strains at its location. Individual strain sets may be identified for processing by singular or combinational use of wavelength selectivity, time-of-flight, coherence scanning, or interferometry. For a given rosette, the FBGs, for example, are at least 50% spatially overlapping in terms of an axial cross-section of the fiber. While FBGs are the preferred sensing element, resonant cavities including pairs of FBGs or other partial reflectors are functionally equivalent.

Because the diameter of the fiber is nominally small (˜100 microns) relative to the pitch length, the cores are approximately parallel to the fiber's length. This permits sensing of bending in nearly the same manner as that described for other multi-core bend-sensing fibers (see prior art). However, the addition of the center “reference core” and the presence of twist bias provides the basis for additionally sensing incremental torsion, and discriminating both bend and torsion from temperature variations. Simply stated, additionally applied torsion in the same direction as the twist bias will elongate the outer FBGs; the torsion in the opposite sense compresses these FBSGs. A simplified geometrical model suggests that strain due to torsion appears in the outer cores approximately as:

$$ɛ = {[ \frac{ {L}_{p}^{2} + {{r}^{2} ( 2 π + δθ {L}_{p} )}^{2}}{ {L}_{p}^{2} + 4 {π}^{2} {r}^{2}} ]}^{1 / 2} - 1$$

where Lₚ is the pitch length of the twist bias, r is the distance from the fiber's center line to the outer core, and δθ is the applied torsion in radians per meter. By example, consider a core radial offset of 50 microns and a twist bias of 30 turns per meter. If torsion is applied at a rate of 10 degrees per meter of fiber length, a signal of 91.4 nanostrains would be predicted for all of the outer, twist-biased cores.

The scale of strains produced in a multi-core fiber used for shape sensing, for example, includes bend-induced signals on the order of 500 microstrains (corresponding to a radius of curvature of 0.1 meter), and 10's of microstrains due to a temperature rise of a few degrees. The present invention includes a minimum of four cores, with one placed near the neutral axis of the fiber. Three classes of strain serve to illustrate the function of the four-core rosette design. First, with temperature or axial tension, strain in all cores varies together. Second, in torsion, the outer FBGs' strains vary together while the center FBG's response is very small. Third, in bending, the outer FBGs strain differentially as determined by the direction of bending, and the central FBG is largely unaffected. A mathematical treatment of these relations enables each combination of bend and torsion to be identified uniquely, with a third separable term representing a combination of temperature and axial tension. This mixed term does not affect shape, and tension is optionally taken to equal zero. A series of these strain rosettes spaced along the fiber is optionally similarly processed to assess the shape at many successive locations, thereby revealing the shape of the length of fiber. Core placement with high symmetry and large separation give the best conditioned strain signals, but processing algorithms optionally accommodate a wide range of geometries and placement tolerance with little loss of performance.

The multiple-core preform is optionally fabricated in a variety of ways, such as bundled rods, insertion of rods in a grooved or drilled preform, sol-gel formation of all waveguides, machined combination of multiple preforms, etc.

Gratings are optionally written in the multicore fiber by various sequences. Each set of four gratings can be written in one pulse during fiber draw, or by an extended process with the fiber held stationary. The four gratings at one fiber location are optionally written in multiple stages, with one exposure for a subset of the set of four gratings so that individual grating properties are optionally tailored. Rotational alignment of the fiber with respect to the laser is optionally used to essentially prevent exposure of one or more cores while other cores are illuminated for grating inscription. Spatially-selective attenuation of the laser beam is optionally used to block exposure of selected cores for this same purpose.

A twist bias is optionally imparted during the draw process by rotating the preform; stability of the fiber at the location of grating writing is likely to be degraded. Twist bias need not be equivalent in magnitude or direction at each of the grating locations. Therefore, twist with a varied magnitude and direction is optionally applied during fiber draw.

In addition to the preferred use of fiber Bragg gratings to sense strain in the fiber, other modifications to the optical fiber may also be employed to sense strain along each of the several light-guiding cores. This may include the formation of optical cavities in the various cores by partial reflectors, or by combinations of Bragg gratings.

While the preferred embodiment describes methods suitable to silica-based optical fiber, the concept is equivalent if realized in fibers composed of other glass compositions.

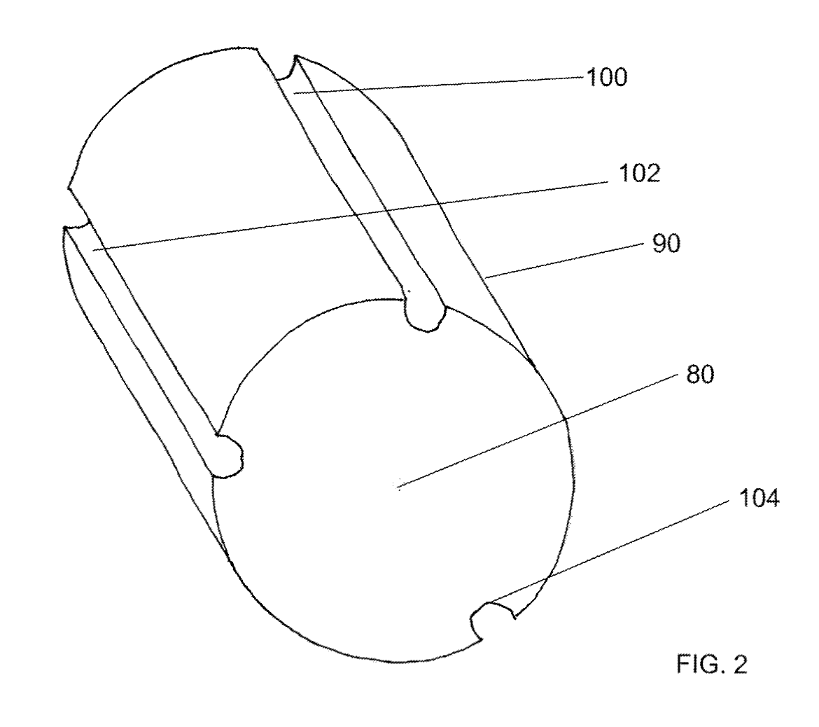

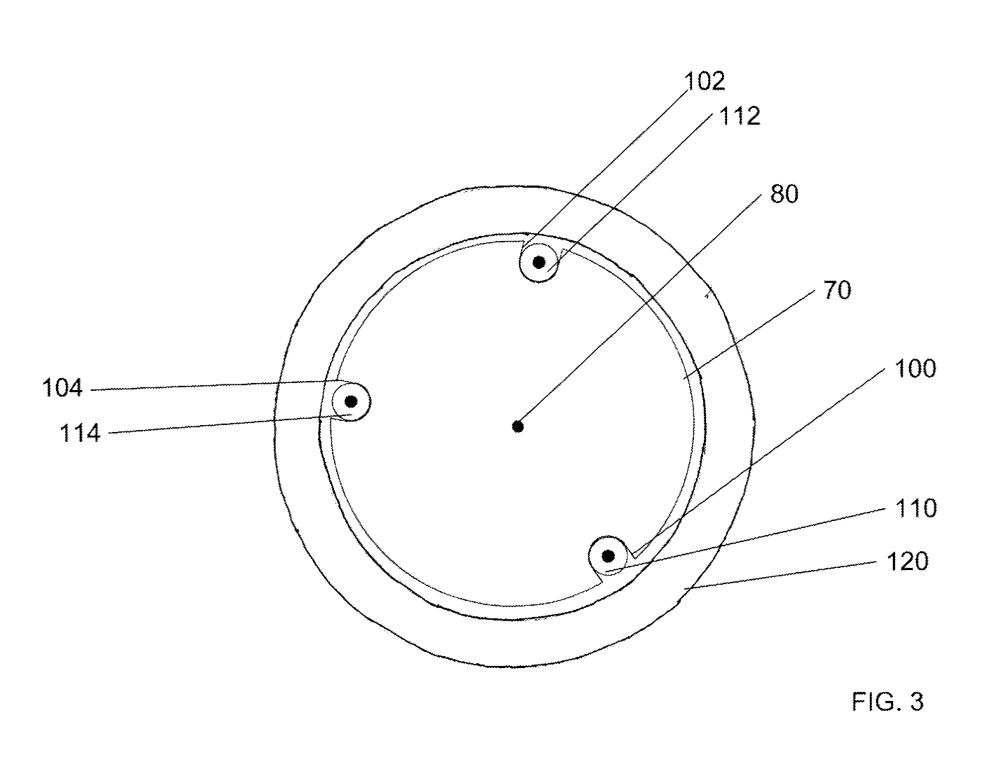

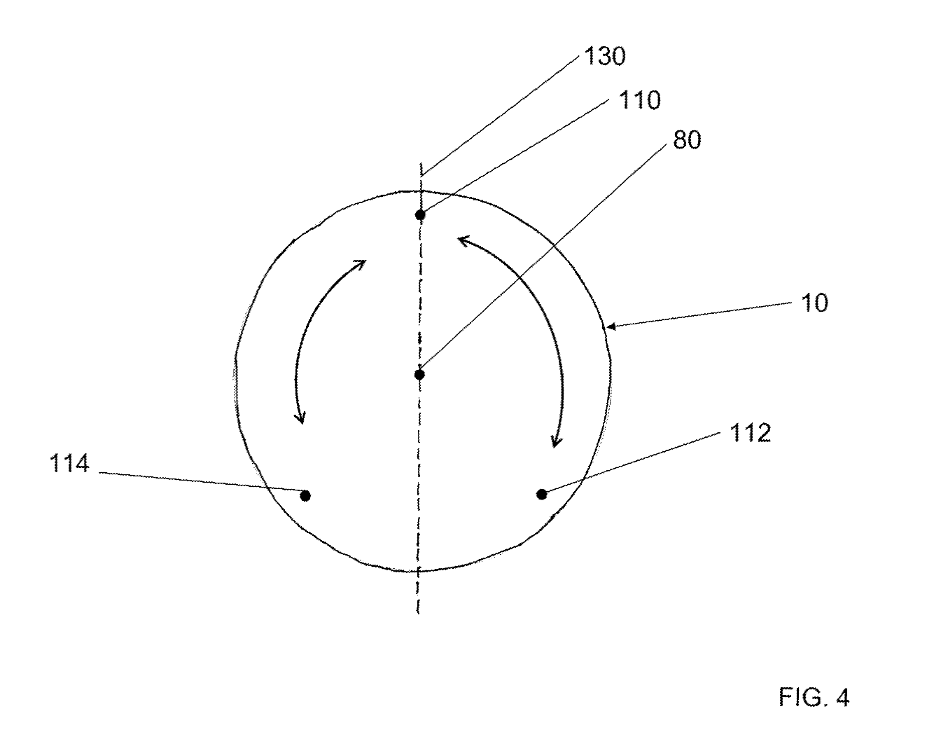

An embodiment of the instant invention includes a method of manufacture, referring by way of example to FIGS. 2-4. The method includes providing a multi-core, single-mode optical fiber pre-form 70 comprising a center single-mode core 80 and a periphery 90. A plurality of longitudinal grooves 100, 102, 104 are machined along the periphery 90. A plurality of peripheral single-mode cores 110, 112, 114 are inserted in said plurality of longitudinal grooves 100, 102, 104. The pre-form 70 is over-sleeved with a glass tube 120 prior to a fiber draw.

Optionally, each peripheral single-mode core of the plurality of peripheral single-mode cores includes a respective index of refraction and/or a respective photosensitivity. Optionally, the plurality of peripheral single-mode cores include a reference single-mode core 110 and at least two remaining peripheral single-mode cores 112, 114, wherein the reference single-mode core 110 and the center single-mode core 80 include a plane 130 perpendicular to the fiber cross-section. The plane is free of the at least two remaining peripheral single-mode cores 112, 114. The respective photosensitivity of each remaining peripheral single-mode core of the at least two remaining peripheral single-mode cores 112, 114 corresponds to an angular position relative to the plane. Optionally, a first azimuthal angle, lies in the fiber cross-section and is formed by the reference single mode core 110, the center single mode core 80, and a first remaining peripheral single-mode core 112 of the at least two remaining peripheral single-mode cores, is the same as a second azimuthal angle, lying in the fiber cross-section and formed by the reference single mode core 110, the center single mode core 80, and a second remaining peripheral single-mode core 114 of the at least two remaining peripheral single-mode cores.

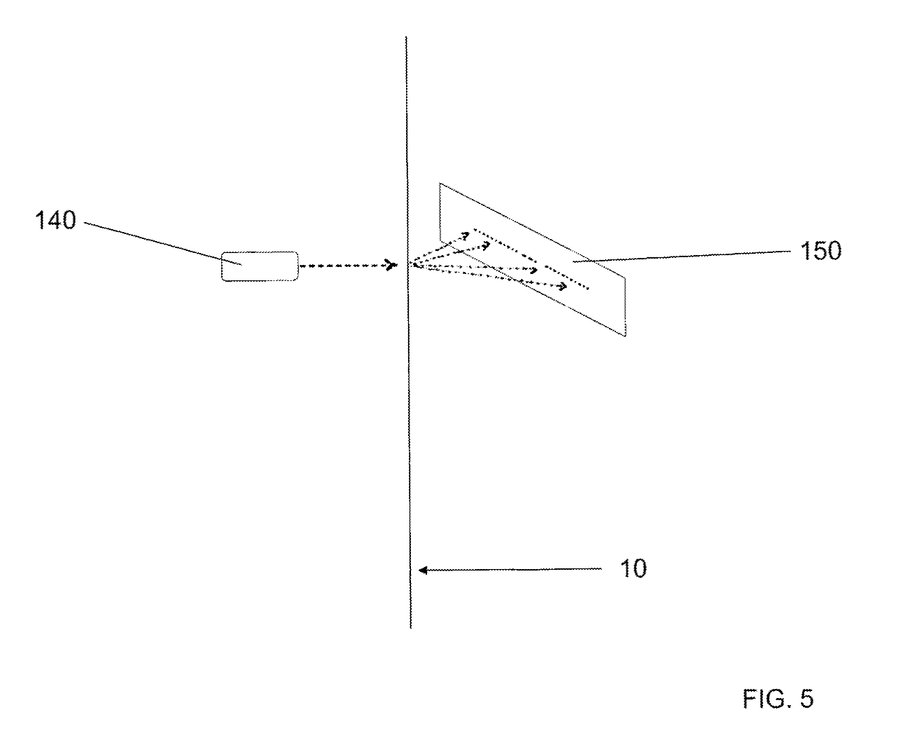

Another embodiment of the invention includes a method of manufacture including providing a multi-core single-mode optical fiber during a fiber draw process, and is described with reference, by way of example, to FIG. 5. A rotation is imparted to the multi-core single-mode optical fiber 10. A rate of the rotation is measured by side illumination with a laser 140. A light scatter pattern 150 is detected. The rate of the rotation in the rotation-imparting step is controlled by adjusting a cross-roller assembly in response to the detected light scatter pattern, thereby producing a permanent twist in the multi-core single-mode optical fiber drawn by the fiber draw process. Optionally, the multi-core single-mode optical fiber includes a length, a longitudinal axis, and a fiber cross-section. Detecting a light scatter pattern includes directing a laser beam toward the multi-core single-mode optical fiber in a direction normal to the longitudinal axis to generate the light scatter pattern determined by the fiber cross-section; displaying the light scatter pattern; and moving a point of incidence of the laser beam along the length of the fiber to measure an amount of twist in the multi-core single-mode optical fiber.

Another embodiment of the invention includes method of manufacture. The method includes providing a multi-core single-mode optical fiber 10, and is described with reference, by way of example, to FIG. 5. The multi-core single-mode optical fiber is rotationally oriented. A rotational orientation of the fiber is measured by side illumination with a monitoring laser 140, wherein the side illumination is substantially free of an effect on the index of refraction of the multi-core single-mode optical fiber. A light scatter pattern 140 is detected. Based on the detected light scatter pattern, the rotational orientation is adjusted during the rotationally orienting of the multi-core single-mode optical fiber step. A fiber Bragg grating is produced in the fiber.

Optionally, the multi-core single-mode optical fiber includes a center single-mode core, a fiber cross-section, and a periphery. The multi-core single-mode optical fiber includes a plurality of longitudinal grooves along the periphery. The multi-core single-mode optical fiber includes a plurality of peripheral single-mode cores located in the plurality of longitudinal grooves. Each peripheral single-mode core of the plurality of peripheral single-mode cores includes a respective index of refraction and/or a respective photosensitivity. The plurality of peripheral single-mode cores includes a reference single-mode core and at least two remaining peripheral single-mode cores. The reference single-mode core and the center single-mode core include a plane perpendicular to the fiber cross-section, the plane being free of the at least two remaining peripheral single-mode cores. The respective photosensitivity of each remaining peripheral single-mode core of the at least two remaining peripheral single-mode cores corresponds to an angular position relative to the plane.

Optionally, the adjusting, based on the detected light scatter pattern, the rotational orientation in the rotationally orienting the multi-core single-mode optical fiber is performed until the light scatter pattern includes reduced intensity regions projected by the plurality of peripheral single-mode cores. The light scatter pattern corresponds to rotational alignment of the plurality of peripheral single-mode cores with the laser, wherein the reference single-mode core of the plurality of peripheral single-mode cores is distal to the monitoring laser relative to the at least two remaining peripheral single-mode cores.

Optionally, a laser optical field is modified by interposing a filamentary attenuator between the fiber and the laser such that a laser beam cross-section comprises a selectively attenuated intensity field. Optionally, the selectively attenuated intensity field is aligned with light illuminating the reference single-mode core of the plurality of peripheral single-mode cores to attenuate exposure of the reference single-mode core of the plurality of peripheral single-mode cores.

Illustrative examples of the above manufacturing methods are described as follows.

A pre-form is assembled with 4 (or more) glass waveguides positioned within optical grade filler glass. A component of this pre-form is waveguide rods consisting of small diameter pre-forms having a low cladding-to-core diameter ratio. In one version, a bundle of filler glass rods includes the four waveguide rods located at appropriate positions within the bundle; one is centrally located, the others are distributed around the periphery of the bundle. The entire bundle is inserted in a glass tube of optical quality, and the ensemble is drawn into fiber. In a second version, an optical fiber pre-form is produced by conventional means, and then longitudinal grooves (with cross sections similar to the waveguide rods) are ground into its surface at locations designated for the outer waveguides Waveguide rods are placed in the grooves, the ensemble is inserted into a glass tube, and the completed ensemble is drawn into fiber. The properties of each waveguide rod are optionally customized to enhance the writing of gratings in the fiber.

Twist bias is imparted during draw by imparting a rotational force to the coated fiber. The fiber passes between a pair of rollers whose rotational axes are tilted relative to each other, and the contacting surfaces produce a rotational force as the fiber passes (alternately, the pre-form is optionally rotated, but this may cause vibrational instability). When the cooling fiber hardens, the outer waveguides are frozen into a helical geometry about the nominally straight central waveguide.

Differential strain measurements are optimal when the set of four FBGs at each axial position are written with the same (unstrained) values of Bragg wavelength and reflectivity. Focusing of the writing laser by the fiber surface produces different levels of intensity at the locations of each core in the fiber. The preferred orientation is to place one core near the side of the fiber opposite where the laser is incident. Other rotations may prevent significant light from illuminating all cores, but may be acceptable for certain applications. Of the four cores, highest intensity is experienced in the core opposite the incident side. The relative intensity in this core is optionally reduced by preferentially attenuating the part of the laser beam which intersects the core. A lens is often used to compress the beam in the direction orthogonal to the fiber's length so as to increase the optical intensity. A wire or fiber (much thinner than the laser beam's width) is optionally positioned in the laser beam, and in a direction parallel to the grating fiber. For example, the diameter of the wire or fiber comprising the filament attenuator is less than 30 nm. By selecting the distance between the wire and location where the beam reaches focus, the shape and sharpness of the shadow can be adjusted to help balance the exposure. Alternately, the balance of intensities inside the fiber is optionally improved by placing a short-focal-length lens to form a focus just before the incident side of the fiber. The highly divergent light helps to cancel the focusing effects of the fiber's surface.

Obtaining a well-matched set of gratings from one laser exposure optionally entails compositional tailoring of each waveguide rod's photosensitivity to compensate for varied intensities. An additional compositional difference is optionally applied in fabricating the central core to compensate for changes in the fiber's index of refraction during the draw process. The amount of drawing-induced index change varies with distance from the center of the fiber. Therefore, the index of the central core is optionally compositionally modified so that after the single writing exposure, the central FBG will reflect at the same wavelength as do the outer FBGs. To provide for more balanced intensities during the writing exposure, the angular placement of the outer cores is optionally adjusted to a less symmetrical arrangement (up to a limit where resolution of bending angle is compromised). Choice of the appropriate compositions would be guided by knowledge of the relative intensities at the cores under writing illumination. Intensities are optionally obtained either by calculation, or by monitoring laser-induced fluorescence guided in a core while the fiber is rotated about its axis relative to the incident laser beam.

The individually constituted cores must be aligned with the contours of laser intensity inside the fiber. The fiber's rotational orientation is optionally monitored and adjusted by inspecting light scattered from a short-wavelength laser beam directed at the side of the fiber. The pattern of scattered light clearly exhibits high contrast interference features (bands of light and dark) which can be intuitively related to the location of each core within the fiber when the outer surface of the fiber is nearly circular. When a core is near the side of the fiber where the light exits, a relatively large feature is projected in a direction affected by rotating the fiber, when the same core is rotated to the incident side, a narrower feature is produced. To enable identification of the single correct alignment with all the customized cores, the angular spacing of the outer cores is optionally made intentionally asymmetrical. The monitoring laser preferably produces a high-contrast diffraction pattern from the small core structures, and it must not induce or erase index changes. For example, the monitoring laser preferably should not induce an index change greater than five percent of the index change constituting the grating. For example, a wavelength near 400 nm is suitable, and compact commercial lasers are available. This alignment technique is suitable for monitoring exposures applied with CW or pulsed lasers where the fiber is held stationary, and in exposures with short pulses of light where the fiber may be in motion.

Because numerous modifications and variations of the above-described invention will occur to those of ordinary skill in the art, it is not desired to limit the invention to the exact construction and operation illustrated and described. Accordingly, all suitable modifications and equivalents may be resorted to, falling within the scope of the invention.

What is claimed is:

1. A method comprising:
providing a multi-core, single-mode optical fiber pre-form comprising a center single-mode core, a fiber cross-section, and a periphery;
machining a plurality of longitudinal grooves along the periphery;
inserting a plurality of peripheral single-mode cores in said plurality of longitudinal grooves; and
over-sleeving the pre-form with a glass tube prior to fiber draw.

2. The method according to claim 1, wherein each peripheral single-mode core of the plurality of peripheral single-mode cores comprises at least one of a respective index of refraction and a respective photosensitivity.

3. The method according to claim 2, wherein the plurality of peripheral single-mode cores comprises a reference single-mode core and at least two remaining peripheral single-mode cores,
wherein the reference single-mode core and the center single-mode core comprise a plane perpendicular to the fiber cross-section, the plane being free of the at least two remaining peripheral single-mode cores, the respective photosensitivity of each remaining peripheral single-mode core of the at least two remaining peripheral single-mode cores being adjusted to correspond to an angular position relative to the plane.

4. The method according to claim 3, wherein a first azimuthal angle, lying in the fiber cross-section and formed by the reference single mode core, the center single mode core, and a first remaining peripheral single-mode core of the at least two remaining peripheral single-mode cores, is the same as a second azimuthal angle, lying in the fiber cross-section and formed by the reference single mode core, the center single mode core, and a second remaining peripheral single-mode core of the at least two remaining peripheral single-mode cores.

5. A method comprising:
providing a multi-core single-mode optical fiber during a fiber draw process;
imparting a rotation to the multi-core single-mode optical fiber;
measuring a rate of the rotation by side illumination with a laser;
detecting a light scatter pattern; and
controlling the rate of the rotation in the rotation-imparting step by adjusting a cross-roller assembly in response to the detected light scatter pattern, thereby producing a permanent twist in the multi-core single-mode optical fiber drawn by the fiber draw process.

6. The method according to claim 5, wherein the multi-core single-mode optical fiber comprises a length, a longitudinal axis, and a fiber cross-section,
wherein said detecting a light scatter pattern comprises:
directing a laser beam toward the multi-core single-mode optical fiber in a direction normal to the longitudinal axis to generate the light scatter pattern determined by the fiber cross-section;
displaying the light scatter pattern; and
moving a point of incidence of the laser beam along the length of the fiber to measure an amount of twist in the multi-core single-mode optical fiber.

7. A method comprising:
providing a multi-core single-mode optical fiber;
rotationally orienting the multi-core single-mode optical fiber;
measuring a rotational orientation of the fiber by side illumination with a monitoring laser, wherein the side illumination is substantially free of an effect on the index of refraction of the multi-core single-mode optical fiber;
detecting a light scatter pattern;
adjusting, based on the detected light pattern, the rotational orientation in said rotationally orienting the multi-core single-mode optical fiber; and
producing a fiber Bragg grating in the fiber.

8. The method according to claim 7, wherein the multi-core single-mode optical fiber comprises a center single-mode core, a fiber cross-section, and a periphery, the multi-core single-mode optical fiber comprising a plurality of longitudinal grooves along the periphery, the multi-core single-mode optical fiber comprising a plurality of peripheral single-mode cores located in the plurality of longitudinal grooves, each peripheral single-mode core of the plurality of peripheral single-mode cores comprising at least one of a respective index of refraction and a respective photosensitivity,
wherein the plurality of peripheral single-mode cores comprises a reference single-mode core and at least two remaining peripheral single-mode cores,
wherein the reference single-mode core and the center single-mode core comprise a plane perpendicular to the fiber cross-section, the plane being free of the at least two remaining peripheral single-mode cores, the respective photosensitivity of each remaining peripheral single-mode core of the at least two remaining peripheral single-mode cores being adjusted to correspond to an angular position relative to the plane.

9. The method according to claim 8, wherein said adjusting, based on the detected light scatter pattern, the rotational orientation in said rotationally orienting the multi-core single-mode optical fiber is performed until the light scatter pattern comprises reduced intensity regions projected by the plurality of peripheral single-mode cores, the light scatter pattern corresponding to rotational alignment of the plurality of peripheral single-mode cores with the laser, wherein the reference single-mode core of the plurality of peripheral single-mode cores is distal to the monitoring laser relative to the at least two remaining peripheral single-mode cores.

10. The method according to claim 8, further comprising:
modifying a laser optical field by interposing a filamentary attenuator between the fiber and the laser such that a laser beam cross-section comprises a selectively attenuated intensity field.

11. The method according to claim 10, further comprising:
aligning the selectively attenuated intensity field with light illuminating the reference single-mode core of the plurality of peripheral single-mode cores to attenuate exposure of the reference single-mode core of the plurality of peripheral single-mode cores.

12. An apparatus comprising:
a fiber comprising an axial center, a central single-mode waveguiding core and a plurality of peripheral single-mode waveguiding cores,
wherein said central core is located at a first distance from said axial center,
wherein said plurality of peripheral cores is located at respective second distances from said axial center,
wherein each of said respective second distances is greater than said first distance,
wherein each peripheral core of said plurality of peripheral cores follows a respective first helix about said axial center, and
wherein said central core and said plurality of peripheral cores comprise an optical strain sensor rosette.

13. The apparatus according to claim 12, wherein said central core is located coincident with said axial center.

14. The apparatus according to claim 12, wherein said fiber comprises an optical surface, said plurality of peripheral cores being located at respective third distances from said optical surface.

15. The apparatus according to claim 14, wherein each of said respective third distances being greater than a diameter of a corresponding peripheral core of said plurality of peripheral cores.

16. The apparatus according to claim 12, wherein said central core follows a second helix about said axial center.

17. The apparatus according to claim 12, wherein each of said first helices comprise a same rotational handedness.

18. The apparatus according to claim 12, wherein said optical strain sensor rosette comprises a plurality of optical strain sensors located at a substantially same fiber length coordinate.

19. The apparatus according to claim 18, wherein said plurality of optical strain sensors comprises one of a fiber Bragg grating and an optical cavity.
